(19) United States
(12) Patent Application Publication
(10) Pub. No.: US 2006/0197930 A1
(43) Pub. Date: Sep. 7, 2006

(54) Exposure method and apparatus

(75) Inventors: Miyoko Kawashima, Haga-gun (JP); Hiroshi Ito, Tokyo (JP); Eiji Sakamoto, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/365,491

(22) Filed: Mar. 2, 2006

(30) Foreign Application Priority Data
Mar. 2, 2005 (JP) 2005-056815

(51) Int. Cl. G03B 27/52

(52) U.S. Cl. 355/55; 355/52; 355/53

(57) ABSTRACT

An exposure method for exposing an image of a pattern of a mask onto a plate while immersing, in liquid, a space between a final lens of a projection optical system and the plate includes the steps of obtaining temperature information of the liquid, determining a correction amount for correcting a focus position of the image based on the temperature information, and correcting the focus position of the image in synchronization with a scan position for one shot based on the correction amount.

### BACKGROUND OF THE INVENTION

The present invention relates generally to an exposure apparatus, and more particularly to a so-called immersion exposure apparatus that immerses, in liquid, a space between a surface of a plate to be exposed and a final surface of a projection optical system, and exposes the plate via the projection optical system and the liquid.

A conventional projection exposure apparatus uses a projection optical system to expose a circuit pattern of a mask (reticle) onto a wafer, etc., and a high-resolution and economically efficient exposure apparatus is increasingly demanded. The immersion exposure is one attractive measure for the high-resolution demands. The immersion exposure promotes a higher numerical aperture (“NA”) of the projection optical system by replacing a medium at the wafer side of the projection optical system with the liquid. See, for example, Japanese Patent Application No. 10-303114. The projection exposure apparatus has an NA of n·sin θ where n is a refractive index of the medium. The NA increases up to n when the filled medium has a refractive index greater than that of air, i.e., n>1. The immersion exposure intends to reduce the resolution R(R=k₁(λ/NA)) of the exposure apparatus, where k₁ is a process constant and X is a wavelength of a light source.

When the immersion exposure uses pure water for the liquid having a refractive index of about 1.44 to the wavelength 193 nm, the NA is 1.44 times as large as the NA of a dry system. For a higher NA, use of an organic medium is proposed. See, for example, S. G. Kaplan et al. (NIST), Characterization of refractive properties of fluids for immersion photolithography, International Symposium on Immersion and 157 nm Lithography (Aug. 3, 2004).

In general, an immersion medium, such as a combined medium and an organic medium, absorbs a larger amount of the light than water, and thus the heat when the exposure light transmits through it. The absorbed heat varies the refractive index of the medium, and its refractive index change to the temperature change is more significant than water. In addition, the medium absorbs the heat not only from the exposure light but also from the wafer, and thus the temperature rise is not stable, and the temperature distribution is biased as shown in FIG. 7. FIG. 7 is a view showing liquid's temperature distributions. The top of FIG. 7 corresponds to a lens side of the projection optical system, and the bottom the wafer side. An interval between a final lens of a projection optical system and the plate or a thickness of the liquid is set to 1 mm. The X direction is set to the scan direction.

According to FIG. 7, the temperature distribution becomes uneven with time, and the wafer's temperature at the right side becomes higher. This is because in addition to a temperature difference that occurs on the wafer between an exposure area and a non-exposure area, a surface temperature varies due to the heat transmission from an adjacent, just previously exposed area. As a result, the refractive index of the medium lowers, and the refractive index distributions becomes uneven, causing a spherical aberration. The spherical aberration causes a focus position of the image to vary within a short time in period during scanning, and hinders high-quality exposure.

### BRIEF SUMMARY OF THE INVENTION

The present invention is directed to an exposure method and apparatus, which provide high-quality exposure at an optimal focus position during scanning.

An exposure method according to one aspect of the present invention for exposing an image of a pattern of a mask onto a plate while immersing, in liquid, a space between a final lens of a projection optical system and the plate includes the steps of obtaining temperature information of the liquid, determining a correction amount for correcting a focus position of the image based on the temperature information, and correcting the focus position of the image in synchronization with a scan position for one shot based on the correction amount.

An exposure method according to another aspect of the present invention for exposing a plate using exposure light while immersing, in liquid, a space between a final lens of a projection optical system and the plate includes the steps of obtaining temperature information of the liquid, and irradiating non-exposure light onto the plate via the liquid based on the temperature information.

An exposure method according to another aspect of the present invention for exposing a plate using exposure light while immersing, in liquid, a space between a final lens of a projection optical system and the plate includes the steps of obtaining information of a temperature of the liquid, and irradiating non-exposure light onto the plane an area whose temperature is below an average of the temperature of the liquid above a periphery of an exposure area of the plate.

An exposure apparatus according to another aspect of the present invention includes a mode for executing the above exposure method. A device manufacturing method according to another aspect of the present invention includes the steps of exposing a plate using the exposure apparatus, and developing the plate that has been exposed.

Other objects and further features of the present invention will become readily apparent from the following description of the preferred embodiments with reference to the accompanying drawings.

### BRIEF DESCRIPTION OF THE DRAWINGS

FIG. 1 is a schematic sectional view of an inventive exposure apparatus.

FIG. 2 is a flowchart showing an exposure method used for the exposure apparatus shown in FIG. 1.

FIG. 3 is a variation of the exposure method shown in FIG. 2.

FIG. 4 is another variation of the exposure method shown in FIG. 2.

FIGS. 5A and 5B are graphs showing amount of driving a lens or a wafer stage.

FIG. 6 is a schematic plane view showing an exposure area on a wafer plane in the exposure apparatus shown in FIG. 1.

FIG. 7 shows temperature changes of a liquid on the wafer plane in the exposure apparatus shown in FIG. 1.

FIG. 8 is a schematic plane view showing an exposure area by exposure light and a exposure area by non-exposure light on the wafer plane in the exposure apparatus shown in FIG. 1.

FIG. 9 is a schematic plane view showing a moving direction at the exposure time in the exposure apparatus shown in FIG. 1.

FIGS. 10A and 10B are schematic plane views showing an exposure area by exposure light and an exposure area by non-exposure light on the wafer plane in the exposure apparatus shown in FIG. 1.

FIG. 11 is a schematic plane view showing an exposure area by exposure light and an exposure by non-exposure light area on the wafer plane in the exposure apparatus shown in FIG. 1.

FIG. 12 is a graph showing a moving speed at the stepping time and a moving speed at the scanning time in the exposure apparatus shown in FIG. 1.

FIGS. 13A and 13B are graphs showing a focus change in a conventional exposure apparatus.

FIG. 14 is a flowchart for explaining manufacture of devices (such as semiconductor chips such as ICs and LCDs, CCDs, and the like).

FIG. 15 is a detail flowchart of a wafer process as Step 4 shown in FIG. 14.

### DETAILED DESCRIPTION OF THE PREFERRED EMBODIMENTS

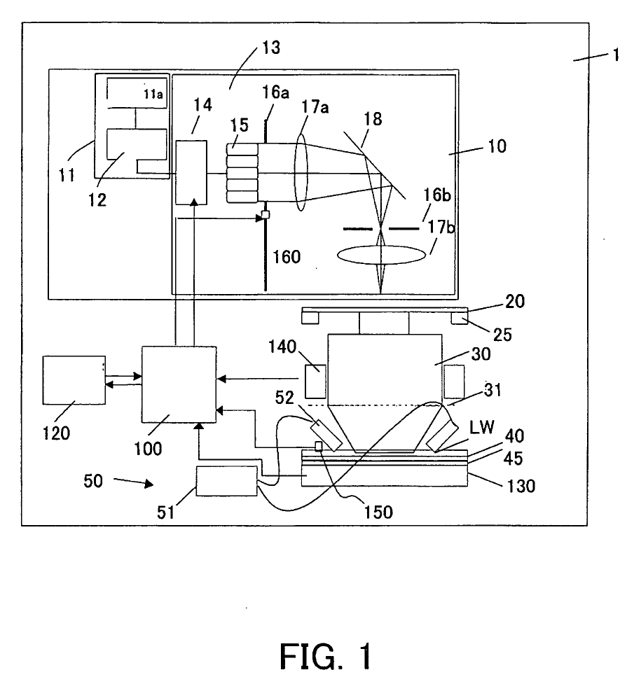

A description will now be given of an exposure apparatus 1 of one embodiment according to one aspect of the present invention with reference to the accompanying drawings. In each figure, like elements are designated by like reference numerals, and a duplicate description will be omitted. Here, FIG. 1 is a schematic block diagram of the exposure apparatus 1.

The exposure apparatus 1 is an immersion type projection exposure apparatus that immerses, in the liquid LW, a space between the wafer 40 and the final surface of the projection optical system 30 closest to the wafer 40, and exposes a circuit pattern of a reticle 20 onto the wafer 40 in a step-and-scan manner. Of course, the exposure apparatus 1 is applicable to a step-and-repeat manner.

This exposure apparatus is suitable for a submicron or quarter-micron lithography process, and this embodiment exemplarily describes a step-and-scan exposure apparatus. The present embodiment uses the step-and-scan exposure apparatus (also referred to as a “scanner”) as an example. The “step-and-scan manner,” as used herein, is an exposure method that exposes a reticle pattern onto a wafer by continuously scanning the wafer relative to the reticle, and by moving, after a shot of exposure, the wafer stepwise to the next exposure area to be shot. The “step-and-repeat manner” is another mode of exposure method that moves a wafer stepwise to an exposure area for the next shot every shot of cell projection onto the wafer.

As shown in FIG. 1, the exposure apparatus 1 includes an illumination optical system 13 including an illumination unit 11, a reticle stage 25 that is mounted with a reticle 20, a projection optical system 30, a wafer stage 45 that is mounted with a wafer 40, an illumination part 50, and a controller 100.

The illumination apparatus 11 includes a light source section 11a and a beam shaping system 12.

The light source section 11a of this embodiment uses as a light source an ArF excimer laser with a wavelength of approximately 193 nm. However, the light source section 11a is not limited to the ArF excimer laser and may use a KrF excimer laser with a wavelength of approximately 248 nm, an F₂ laser with a wavelength of approximately 157 nm, etc. The number of laser units is not limited. A light source applicable to the light source section 11a is not limited to a laser, and may use one or more lamps such as a mercury lamp and a xenon lamp.

The beam shaping system 12 can use, for example, a beam expander, etc., with a plurality of cylindrical lenses. The beam shaping system 12 converts an aspect ratio of the size of the sectional shape of a parallel beam from the laser 11a into a desired value (for example, by changing the sectional shape from a rectangle to a square), thus reshaping the beam shape to a desired one. The beam shaping system 12 forms a beam that has a size and divergent angle necessary for illuminating an optical integrator 15 described later.

The illumination optical system 13 is an optical system that illuminates the reticle 20, and includes lenses 17a and 17b, a mirror 18, an optical integrator 15, stops 16a and 16b, etc. The illumination optical system 13 may arrange, for example, a condenser lens, a fly-eye lens, an aperture stop, a condenser lens, a slit, and an imaging optical system in this order. The optical integrator 15 may include a fly-eye lens or an integrator formed by stacking two sets of cylindrical lens array plates (or lenticular lenses), and may be replaced with an optical rod or a diffraction element. The illumination optical system 13 can use any light whether it is on-axial or off-axial light.

The condensing optical system 14 includes necessary deflecting mirror(s) and lens(es), and efficiently introduces a beam into the optical integrator 15. For example, the condensing optical system 14 includes such a condenser lens that an exit plane of the beam shaping system 12 and an incident plane of the above optical integrator 15 as a fly-eye lens have a relationship of an object plane and a pupil plane (or a pupil plane and an image plane). This relationship may be referred to as a Fourier transformation relationship in this application. The principal ray of the light that passes the condensing optical system 14 is maintained parallel to any lens element at the center or periphery of the optical integrator 15.

The condensing optical system 14 further includes an exposure dose regulator that can change an exposure dose of the illumination light for the mask 20 per illumination. The exposure dose regulator (not shown) is controlled by the controller 100, and changes a beam sectional shape of the incident light by changing each magnification of an afocal system, or a zoom lens, etc., which moves in the optical-axis direction and changes an angular magnification.

The shaped beam from the laser passes the condensing optical system 14 that has a polarization element, and is directed onto the incident plane of the optical integrator 15. The beam from the laser is a linearly polarized light, and the polarization element, such as a wave plate, controls a polarization direction in the condensing optical system 14.

The optical integrator 15 makes uniform illumination light that illuminates the mask 20, and forms a plurality of secondary light sources near the exit plane. When the optical integrator 15 is a fly-eye lens, it includes a multiplicity of rod lenses or fine lens elements. However, as discussed above, the optical integrator 15 usable for the present invention is not limited to the fly-eye lens, and can include an optical rod, a diffraction grating, a plural pairs of cylindrical lens array plates that are arranged so that these pairs are orthogonal to each other, etc.

Provided right after the exit plane of the optical integrator 15 is the aperture stop 16a that has a fixed shape and diameter. The aperture stop 16a is arranged at a position approximately conjugate to the effective light source on the pupil 31 of the projection optical system 30, as discussed later, and the aperture shape of the aperture stop 16a corresponds to the effective light source shape on the pupil 31 plane in the projection optical system 30. The aperture stop 16a controls a shape of the effective light source, as described later.

Various aperture stops 16a can be switched in accordance with the illumination condition so that it is located on the optical path by a stop exchange mechanism (or actuator) 160. The aperture stop 16a may be integrated with polarization control means.

The condenser lens 17a collects all the beams that have exited from a secondary light source near the exit plane of the optical integrator 15 and passed through the aperture stop 16a. The beams are reflected by the mirror 18, and uniformly illuminate or Koehler-illuminate the masking blade 16b plane.

The masking blade 16b includes plural movable light shielding plates, and has an approximately rectangular opening shape when the projection optical system 30 is dioptric. The light that has passed through the opening of the masking blade 16b is used as illumination light for the reticle 20. The masking blade 16b is a stop having an automatically variable opening width, thus longitudinally changing a transfer area on the wafer 40 corresponding to an aperture slit. The exposure apparatus 1 may further include a scan blade, with a structure similar to the above masking blade 16b, which laterally varies the transfer area as a one-shot scan exposure area. The scan blade is also a stop having an automatically variable opening width, and is placed at an optically approximately conjugate position to the plane of the reticle 20. The exposure apparatus 1 uses these two variable blades to set the dimensions of the transfer area in accordance with the dimensions of an exposure shot.

The imaging lens 17b transfers an aperture shape of the masking blade 16b onto the reticle 20 plane to be illuminated, and projects a reduced image of the reticle 20 onto the wafer 40 plane installed on a wafer chuck (not shown).

The reticle 20 has a circuit pattern or a pattern to be transferred, and is supported and driven by a reticle stage 25. Diffracted light emitted from the reticle 20 passes the projection optical system 30, and then is projected onto the wafer 40. The reticle 20 and the wafer 40 are arranged in an optically conjugate relationship. The exposure apparatus in this embodiment is scanner and therefore, synchronously scans the reticle 20 and the wafer 40 at a ratio of a reduction ratio to transfer a pattern on the reticle 20 onto the wafer 40. If it is a step-and-repeat exposure apparatus (referred to as a “stepper”), the reticle 20 and the wafer 40 remain stationary during exposure.

The reticle stage 25 is installed on a stage stool. The reticle stage 25 supports the reticle 20 via a reticle chuck, and is moved by a transport mechanism (not shown) and the controller 100. The transport mechanism (not shown) is made of a linear motor and the like, and drives the reticle stage 25 in an X direction, thus moving the reticle 20.

The projection optical system 30 serves to image the diffracted light that has been generated by the patterns of the reticle 20 onto the wafer 40. The projection optical system 30 may use a dioptric optical system solely composed of a plurality of lens elements, a catadioptric optical system comprised of a plurality of lens elements and at least one concave mirror, etc. Any necessary correction of the chromatic aberration may use a plurality of lens units made from glass materials having different dispersion values (Abbe values), or arrange a diffractive optical element such that it disperses in a direction opposite to that of the lens unit.

The wafer 40 is fed from the outside of the exposure apparatus 1 by a wafer feeding system (not shown), and is supported and driven by the wafer stage 45. The wafer 40 is replaced with a liquid crystal plate and another plate to be exposed in another embodiment. A photoresist is coated on the wafer 40.

The wafer 40 is supported by the wafer stage 45 by the wafer chuck (not shown). The wafer stage 45 serves to adjust a longitudinal or vertical position of the wafer 40 and its inclination in the rotating direction, and is controlled by a stage controller 130. During exposure, the stage controller 130 controls the wafer stage 45 so that the focal plane of the projection optical system 30 always accords with the wafer 40 surface.

The illumination part 50, different from the light source section 11a, irradiates non-exposure light onto the wafer 40, and includes a light source section 51, and a plurality of illumination optical systems 52. The illumination part 50 illuminates the non-exposure area around the exposure area of the liquid LW by using the light source section 51 having a wavelength different from that of the light source section 11a. The light source section 51 uses, for example, a He—Ne laser with a wavelength of 633 nm, and emits the non-exposure light that does not resolve the resist. For example, the light source section 51 may irradiate, from two directions, the non-exposure light onto a non-exposure area around an exposure area which extends in a direction orthogonal or parallel to the scan direction from the exposure area.

The controller 100 controls and communicates with an input/output (“I/O”) device 120, a stage controller 130, a projection optical system controller 140, a detector 150, and an actuator 160, so as to control the aperture stop 16a, the projection optical system 30, and the wafer stage 45.

The I/O device 120 inputs and outputs data. The data contains information obtained from the controller 100.

The stage controller 130 controls driving of the reticle stage 25 and the wafer stage 45.

The projection optical system controller 140 drives the projection optical system 30 in the vertical or Z direction in response to a driving amount for driving so provided from the controller 100. The projection optical system 140 may enclose or support, via plural points, a lens and/or mirror barrel of the projection optical system 30.

The detector 150 detects a temperature of the liquid LW on the wafer 40. The detector 150 may be located above and/or below the wafer (or at the front side and/or rear side of the wafer).

The actuator 160 switches the aperture stop 16a so that it is aligned with the optical path. The controller 100 controls driving of the actuator 160.

The liquid supply part (not shown) serves to supply the liquid LW between the projection optical system 30 and the wafer 40.

The liquid LW serves to shorten the equivalent wavelength of the exposure light from the light source section 11a, and improve the exposure resolution. This embodiment uses, but is not limited to, pure water for the liquid LW. The liquid LW should have a high transmittance and a high refractive index to the exposure light, and be chemically stable to the projection optical system 30 and the resist on the wafer 40. For example, the liquid LW may be fluorine inert fluid or water with a minute amount of additive. The high refractive index liquid cover pure water blended with one of ions of H⁺, Cs⁺, K⁺, Cl⁻, SO₄²⁻, PO₄²⁻ etc., blended with molecules such as alcohol, organic matters, hexane, peptane, octane, etc.

A liquid recovery part (not shown) recovers, via a recovery pipe, the liquid LW supplied to a space between the final surface of the projection optical system 30 and the wafer 40. The liquid recovery part includes, for example, a tank that temporarily stores the recovered liquid LW, and a suction part that sucks the liquid LW.

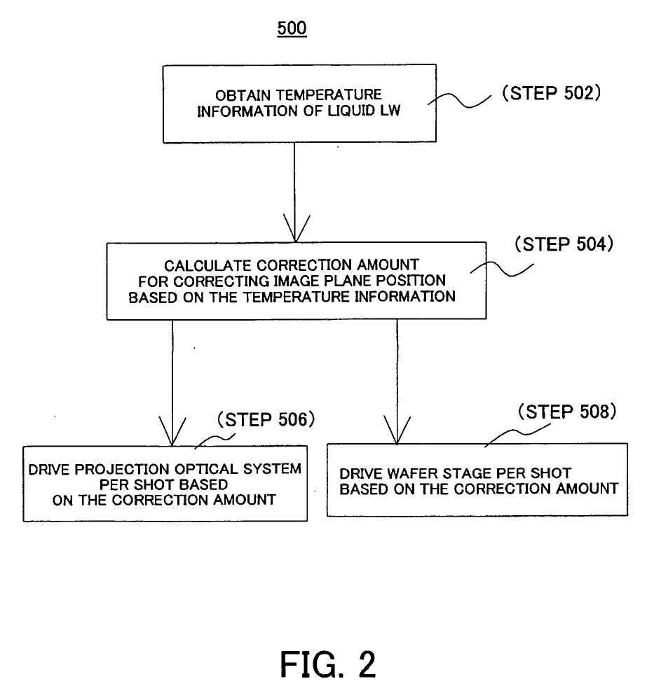

Referring now to FIG. 2, an exposure method 500 will be described. FIG. 2 is a flowchart showing the exposure method 500.

### First Embodiment

The light that passes the reticle 20 and reflects a reticle pattern is imaged on the wafer 40 via the projection optical system 30 and the liquid LW. The liquid LW's temperature information or aberration information (collectively referred to as “temperature information” in this specification unless otherwise specified) is obtained (step 502). The temperature information covers both temperatures above an exposure area and a periphery of the exposure area (or a non-exposure area) on the wafer. The temperature information above the exposure area is important. This embodiment obtains the temperature of the liquid LW using the detector 150.

By using a constant that indicates a refractive index change to a temperature change, the temperature distribution is multiplied by the constant and converted into the refractive index, or aberration or a focus error. The “focus error,” means a change of an imaging position of a reticle pattern, or a change of a focal position of an image of a reticle pattern. On the contrary, it is possible to measure the focus error and convert it into the temperature distribution. Therefore, an object to be measured may be either the temperature distribution or such as a focus error.

One embodiment measures the temperature distribution above the exposure area or the focus error in test exposure prior to exposure to actual devices, and stores the data. An alternative embodiment obtains the temperature information above the exposure area using a heat simulation using parameters of the optical system and physical property values of the immersion liquid. The obtained temperature information is fed to the controller 100.

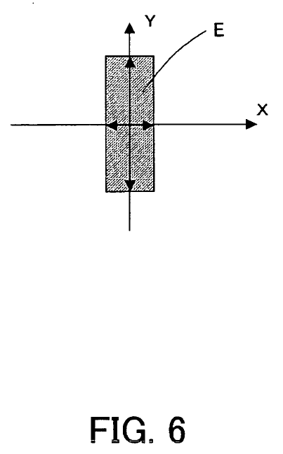

A correction amount used to correct the focus position is determined based on the temperature information (step 504). The correction amount is calculated by the controller 100. The temperature information is obtained at a scan position. Then, the projection optical system 30 is driven based on the correction amount at the scan position (step 506). This embodiment sets the X direction to the scan direction, and the Y direction to the direction orthogonal to the scan direction. FIG. 6 is a plane view of the exposure area E.

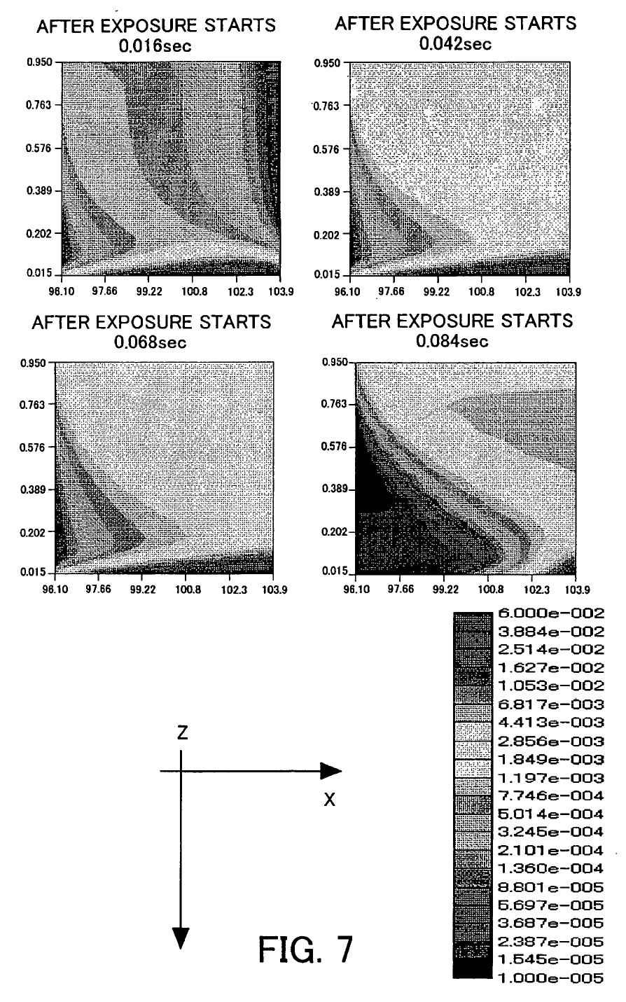

When the exposure area E is scanned and exposed in the X direction at a regular speed, temperature changes of the liquid LW in the section of the exposure area E at Y-0 is as shown in FIG. 7 along the X axis.

The ordinate axis in FIG. 7 is parallel to the optical axis as the light traveling direction. The minus side (an upper side in FIG. 7) corresponds to the lens side, and the plus side (a lower side in FIG. 7) corresponds to the wafer side. And a space between a final lens of a projection optical system and the plate, that is thickness of the liquid, is set to 1 mm. Each view shows a temperature distribution after one-shot exposure time period is divided by 4 and shifted by ¼ shot time period. In other words, the left side to the right side in FIG. 7 is a time variance of a temperature distribution within one shot.

When the exposure light heats up the metal wafer 40, the liquid LW is also heated by the heat transmission. In addition, the liquid LW is directly heated by the exposure light.

The refractive index distribution occurs in the liquid LW due to the temperature distribution, and the aberration due to the liquid LW occurs. The refractive index distribution is calculated by multiplying the temperature distribution of the liquid LW by dn/dt, which is a refractive index change relative to the temperature change) and then the aberration can be calculated.

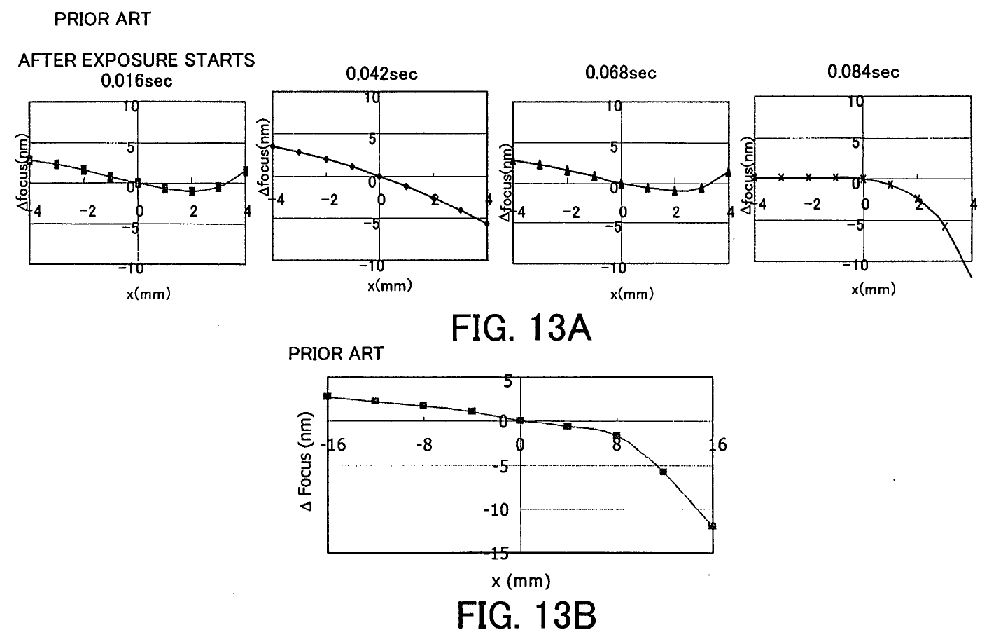

In this embodiment, a change of focus error caused by the temperature change shown in FIG. 7 after the ¼ shot exposure time period becomes as shown in FIG. 13A, where the origin O on the X-axis is the center of the exposure area. FIGS. 13A and 13B are views showing focus changes. This focus change shows the amount of focus error after removing offset of a focus. This focus change indicates a variation amount after a focus offset is removed.

This focus error occurs due to an aberration, in particular a spherical aberration, caused by the refractive index distribution in a short time period in one shot. This focus error occurs in a short time period is not negligible in comparison with a decrease of the depth of focus.

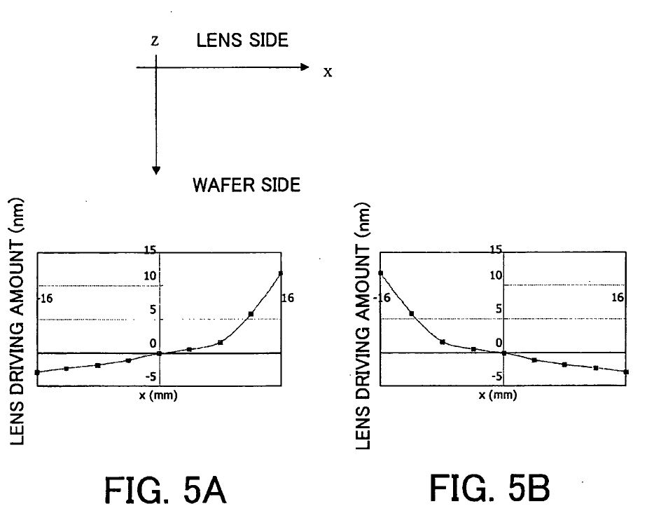

FIG. 13B is a focus change within one shot to a scan position for exposure. The X-axis denotes a scan position, and the origin O on the X-axis is arbitrary. an optical component, such as a lens, in the projection optical system 30 or, such as a wafer atage, in the projection optical system 130 is moved in the Z direction in synchronization with scanning so as to correct and cancel out the focus change within one shot to the scan position for exposure shown in FIG. 13B. Here, FIG. 13B is a graph showing a focus change to the scan position. In other words, as shown in FIGS. 5A and 5B, a space between a final lens in the projection optical system 30 and resist 40 on wafer 45 is moved so as to cancel the focus change shown in FIG. 13B that occurs the aberration of the liquid LW. FIG. 5A is a graph that plots amount of focal compensation n the Z direction relative to the X position when it is scanned in the +X direction. When the scan direction is reversed to the −X direction, the driving amount in the Z direction is also inverse with respect to the X position as shown in FIG. 5B. Here, FIGS. 5A and 5B are graphs showing the amount of focal compensation. The amount of compensation differs according to a shot position or scanning positions.

Alternatively, the wafer stage 45 is driven relative to the scan position per one shot based on the correction amount (step 508). In this case, step 508 may also correct the inclination of the focal plane or wafer 40 plane. In this case, a tile of the wafer stage 45 within one shot is changed at a high speed, and the wafer stage 45 is moved longitudinally. Alternatively, a lens in the projection optical system 30 may be moved in the Z direction in synchronization with scanning and a tilt of the wafer stage 45 within one shot is changed at a high speed.

However, it is generally presumed that the liquid LW is an inorganic or organic matter added pure water as a higher refractive index is sought. Then, the liquid LW's viscosity becomes higher than pure water. In this case, the stage's inclination is changed while the wafer stage 45 is scanned in the X direction and Z direction at a high speed. Then, the pressure occurs from the liquid LW. In order to move the wafer stage 45, the necessary force is larger for the liquid LW of this material than for the liquid LW of pure water. Thus, it is presumed that the water stage 45 deforms and the heat occurs. The force reduces when the lens that does not move in the X direction is moved in the Z or vertical direction. As described above, the driving amount of the lens in the Z direction may be previously stored in the controller 100 by calculating the focal plane changing amount using various physical quantities, such as a physical property value of the liquid LW, a distance between the lens and the water, a stage speed, the exposure dose on the wafer 40 plane, an illumination condition, a reticle's transmittance, and a NA of the projection optical system 30. Alternatively, a focus position within one shot may be measured through the test exposure, or the temperature distribution or refractive index distribution of the liquid LW is measured during the exposure and the driving amount may reflect it.

The aberration of the projection optical system 30 may be corrected. More specifically, the variation with time of aberration of the projection optical system 30 is more moderate than that of the liquid LW. Thus, the aberration of the projection optical system 30 is corrected through longitudinal and rotational driving of the water stage, while the aberration of the liquid LW may be corrected through longitudinal driving of the projection optical system 30. Alternatively, both the aberration of the projection optical system 30 and the aberration of the liquid LW may be corrected through longitudinal driving of the projection optical system 30, or longitudinal driving of the projection optical system 30 and rotational driving of the water stage 45, and longitudinal driving of the projection optical system 30 and longitudinal driving of the water stage 45.

The above method can reduce the image performance deterioration due to the spherical aberration and provides high-quality exposure.

### Second Embodiment

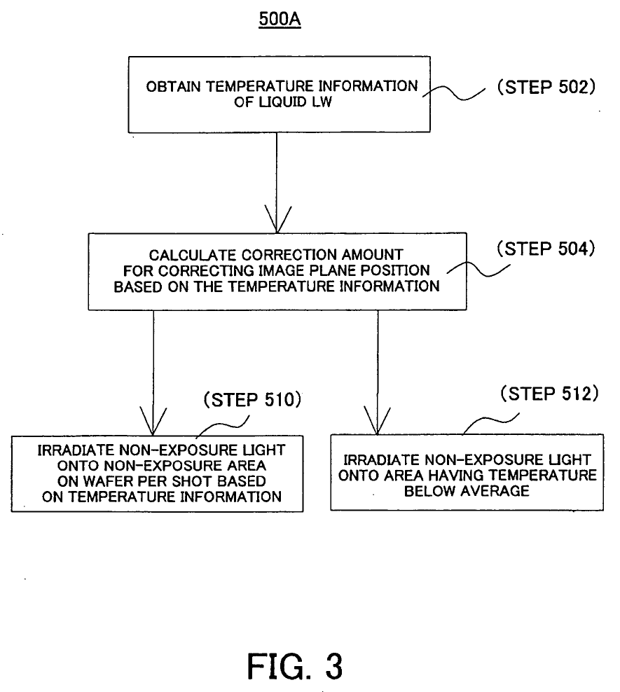

Referring now to FIG. 3, an exposure method 500A will be described. FIG. 3 is a flowchart of the exposure method 500A.

The light that passes the reticle 20 and reflects a reticle pattern is imaged on the wafer 40 via the projection optical system 30 and the liquid LW. The liquid LW's temperature information is obtained (step 502). Similar to the first embodiment, the temperature information may be obtained by measuring the temperature distribution or the focus position change. The temperature information may be obtained previously or during exposure. This embodiment obtains the temperature of the liquid LW using the detector 150. The obtained temperature information is fed to the controller 100.

The dose of the non-exposure light as a correction amount is determined based on the temperature information (step 504). The correction amount is calculated by the controller 100. The temperature information is obtained every shot. When there is no temperature information of the vicinity of the exposure area, the exposure dose of the non-exposure light may be set equal to that of the exposure light.

Next, the non-exposure light is irradiated onto the non-exposure light area on the wafer 40 every one shot based on the temperature information (step 510). Step 510 irradiates the non-exposure area in the direction orthogonal to the scan direction of the exposure area on the wafer 40.

Alternatively, the non-exposure light is irradiated onto a location of the non-exposure area where the temperature of the liquid above it is below the average (step 512). The non-exposure light is irradiated based on the temperature information, when the scan starts.

In the exposure area E, as shown in FIG. 6, the scan direction is set to the X direction and the direction orthogonal to the scan direction is set to the Y direction. Here, FIG. 6 is a plane view showing the exposure area E. When the exposure area E is scanned and exposed at a regular speed in the X direction, the temperature change of the liquid LW on the section along the X axis is as shown in FIG. 7. When the exposure light heats up the metal wafer 40, the liquid LW is also heated by the heat transmission. In addition, the liquid LW is directly heated by the exposure light.

The temperature distribution on the section slightly changes as the section is shifted in the Y direction, because the temperature distribution occurs in the Y direction. In particular, as the section separates from the X-axis or at the end of the exposure area E, the temperature difference from the center of the exposure area on the section along the X-axis.

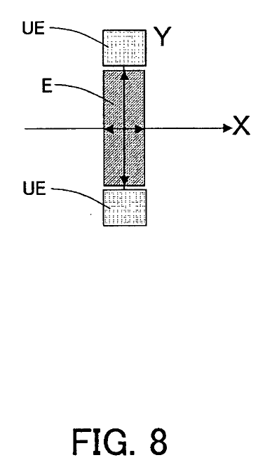

In order to avoid this problem, the non-exposure light having the dose almost equal to that of the exposure light is irradiated, as shown in FIG. 8, onto the non-exposure area UE around the boundary with the exposure area. The non-exposure light is irradiated from a position above the liquid onto the peripheral position of the exposure area on the focal plane, so as to heat the top of the liquid above the periphery of the exposure area. Here, FIG. 8 is a plane view of the exposure area E and the non-exposure area UE. The non-exposure light is the light that does not resolve the resist, for example, a He—Ne laser (having a wavelength of 633 nm), and is emitted from a light source different from an exposure light source. A type of the non-exposure light is not limited as long as it is the non-exposure light that does not resolve the resist. Using fiber, the light source 51, and the illumination optical system 52 around the projection optical system 30, the non-exposure light having energy similar to the exposure light is irradiated onto the liquid LW above the non-exposure area UE around the exposure area E.

The irradiation energy of the non-exposure area is adjustable so as to cancel the heat's Y-direction distribution transmitted from the lens that accumulates the heat due to the exposure light. When there is a difference of the heat transmission from (for example, a peripheral shot on) the wafer 40 between both ends in the Y direction, the irradiation energy of the non-exposure light can be adjusted so as to cancel the distribution in the Y direction.

When the uniform energy is continuously irradiated over the exposure area and non-exposure area, and the exposure area has the uniform heat distribution in the Y direction and thus the uniform refractive index distribution. As a result, the high-quality exposure is obtained because the focus change becomes uniform on the focus position caused by the aberration, the correction amount becomes uniform, and the error residue can be made close to zero.

The light source 51 different from the light source 11a can be used for an alignment measurement, focus change due to the aberration, distortion change, and other measurements.

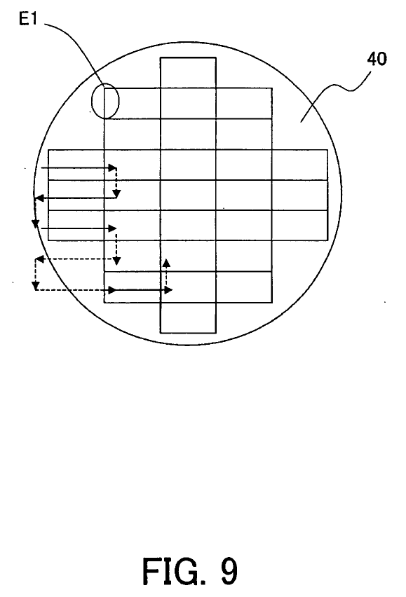

The exposure apparatus 1 scans the exposure area on the wafer 40 as shown in FIG. 9, and steps to the end of the next adjacent exposure area, and then scans and exposes the next adjacent exposure area. The arrow denotes the scan direction, and the broken-line direction denotes the stepping direction. In addition, FIG. 9 is a plane view showing a moving direction at the exposure time. The wafer 40 has plural rectangular areas shown in FIG. 9, and peripheral shots E1 that do not have an adjacent exposure area at least at one side. When the exposure area is exposed on the wafer 40, the heat spreads to the adjacent exposure area. The plane heat distribution on the wafer 40 is small at the periphery of the wafer 40 and large at the center of the wafer 40.

With respect to the heat transmitted to the liquid LW, the heat transmitted from the metal wafer 40 having a large specific heat dominates, and depends upon the plane heat distribution on the wafer 40. The peripheral shot has a different heat distribution from the non-peripheral shot that has an adjacent exposure area E, such as a central shot, and thus the aberration variance amount and correction amount.

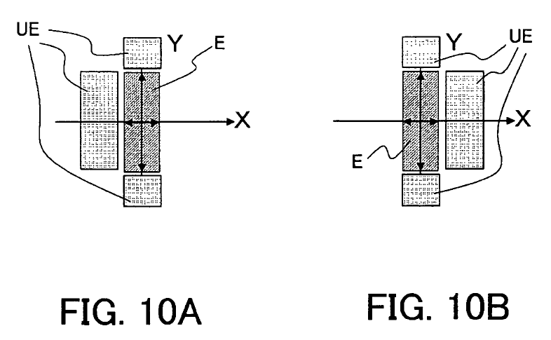

For the peripheral shot that does not have an adjacent exposure area E at least at one side, for example, at the left side, the non-exposure light may be irradiated from the left side parallel to the scan direction for the exposure area E, as shown in FIG. 10A. For the peripheral shot that does not have an adjacent exposure area E at the right side, the non-exposure light may be irradiated from the right side parallel to the scan direction for the exposure area E, as shown in FIG. 10B.

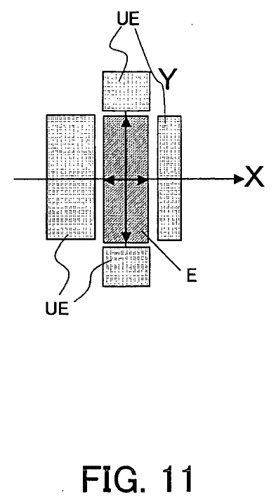

As shown in FIG. 11, the non-exposure light may be irradiated onto the periphery of the exposure area E or the non-exposure area US asymmetrically. Alternatively, the correction (irradiation may be adjusted in accordance with a programmed correction amount (irradiation amount) for the wafer 40 for properly correcting both the peripheral shot and the non-peripherally shot. In addition, in order to mitigate the aberrational asymmetry that occurs when the scan starts and ends, the non-exposure light may be irradiated at the side opposite to the scan direction only when the scan starts because the aberration is less likely to occur when the scan starts. For example, when the scan direction is +X direction (right side) as in FIG. 10A, the non-exposure light is irradiated onto the minus side (left side) of the exposure area when the scan starts.

In addition to the peripheral shot and the scan starting time, the heat distribution is given to the periphery of the exposure area E, as shown in FIG. 11, and the non-exposure light may be always irradiated. The irradiation amount onto the wafer plane or immersion material has such a distribution that changes by location that the temperature can be uniform on the wafer plane or in the immersion material. In addition, as shown in FIG. 9, the irradiation amount may change by time, because the temperature distribution differs according to shot positions and scan positions.

The above method can make uniform the temperature distribution of the liquid LW, and reduce or eliminate a difference between the aberration of the peripheral shot and that of the non-peripheral shot. Then, prior to exposure, the focus position is corrected with the correction amount calculated by step 504 and the conventional method or the method of the first embodiment that corrects the focus position in synchronization with the scan position.

### Third Embodiment

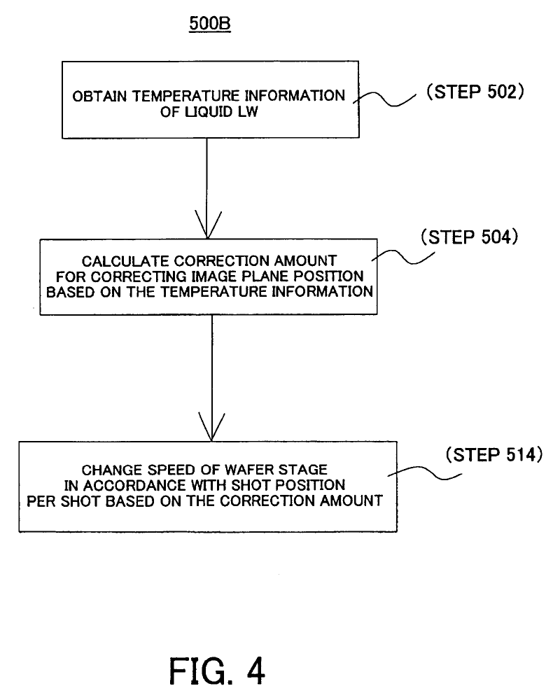

Referring now to FIG. 4, an exposure method 500B will be described. FIG. 4 is a flowchart of the exposure method 500B.

The light that passes the reticle 20 and reflects a reticle pattern is imaged on the wafer 40 via the projection optical system 30 and the liquid LW. The liquid LW's temperature information is obtained (step 502). Similar to the first embodiment, the temperature information may be obtained by measuring the temperature distribution or the focus change. The temperature information may be obtained previously or during exposure. This embodiment obtains the temperature of the liquid LW using the detector 150. The obtained temperature information is fed to the controller 100.

A correction amount for correcting the focus position is determined based on the temperature information (step 504). The correction amount is calculated by the controller 100. The temperature information is obtained every shot.

Next, the speed of the wafer stage 45 is changed every shot position according to the shot positions based on the temperature information on the wafer 40 (step 514).

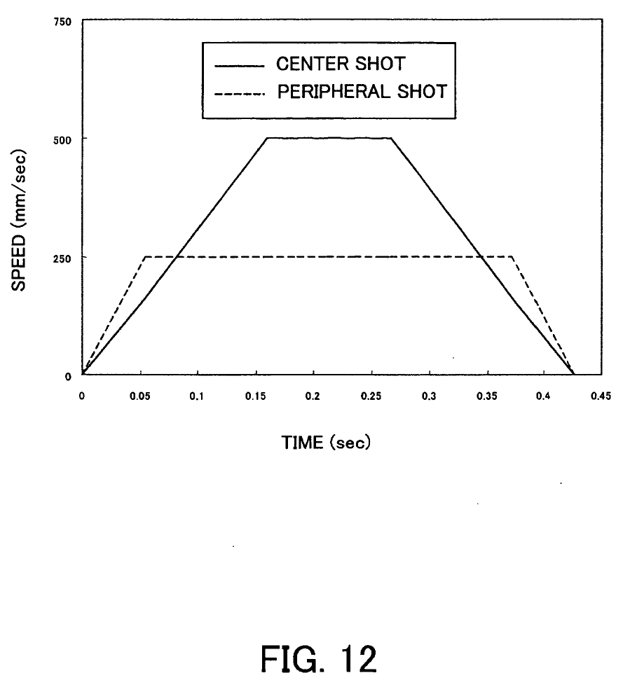

Referring now to FIG. 12, a description will be given of an exposure method when there is a difference of the temperature distribution of the liquid LW between the peripheral shot and the non-peripheral shot or an aberration difference between them. FIG. 12 shows, for example, a moving speed at the stepping time and a moving speed at the scanning time on the peripheral and non-peripheral shots. FIG. 12 is illustrative, and the moving speed at the stepping time and the moving speed at the scanning time are not limited to the examples in FIG. 12. A total time necessary for a movement at the stepping time and a movement at the scanning time does not have to be the same between the peripheral and non-peripheral shots unlike FIG. 12. As the stage moving speed is low, the temperature distribution of the liquid LW or the generated aberration has a large variance. In order to make uniform the thermal variance between the peripheral shot and the center shot, the stage speed is changed at the scanning time according to shot positions on the wafer 40 during exposure. Additionally or alternatively, the time interval at the stepping time of the peripheral shot is changed according to shot positions. The stage moving speed is made slow at the scanning time for the non-peripheral shot area, so as to prolong the time interval to the next exposure (by reducing the acceleration at the stepping time or standing by maintaining the acceleration) and to radiate the heat or reduce the accumulated heat value.

On the other hand, for the peripheral shot, the stage moving speed at the scanning time is made fast so as to shorten the time period to the next exposure (by increasing the acceleration at the stepping time or maintaining the acceleration without standby). This is because the thermal variance of the non-peripheral shot that prolongs the time interval to the next exposure is larger than that of the peripheral shot.

In this case, if the scanning time and the stepping time are previously made constant and temperature information 1 is obtained by the usual exposure method prior to exposure, temperature information 2 indicative of a temperature distribution becomes different from the temperature information 1 when the stage moving speed at the scanning time and the exposure downtime necessary to move to the next exposure position are controlled according to shot positions on the wafer. The stage moving speed at the scanning time and the exposure downtime may be optimized based on the temperature information 2 by feeding back the temperature information 2.

Then, prior to exposure, the focus position is corrected with the correction amount calculated by step 504 and the conventional method or the method of the first embodiment that corrects the focus position in synchronization with the scan position.

This method can make uniform the temperature distribution of the liquid LW or the generated aberration between the peripheral shot and that of the non-peripheral shot. As a result, the liquid makes uniform the refractive index distribution on the entire wafer, mitigating a partial generation of uneven spherical aberration. Thus, the spherical aberration on the entire wafer becomes uniform. As a result, the high-quality exposure is obtained because the error residue after the correction is minimized.

Each of the first to third embodiments is independently effective, but when the first and second embodiments are combined, the temperature distribution of the liquid LW or the generated aberration can be made even between the peripheral shot and the non-peripheral shot. This combination enhances the effect of the correction, and minimizes the aberrational influence of the liquid LW. This effect is further enhanced when all of the first to third embodiments are combined.

These embodiments are directed to a method of correcting an aberration of the liquid LW in immersion exposure that uses liquid LW that absorbs the light or has a large dn/dT, and is effective to a reduction of aberrational influence of the liquid LW. While this embodiment exemplifies a high refractive index immersion material, the present invention is effectively applicable to pure water because the aberrational influence of the liquid LW is not negligible even when the liquid LW is pure water.

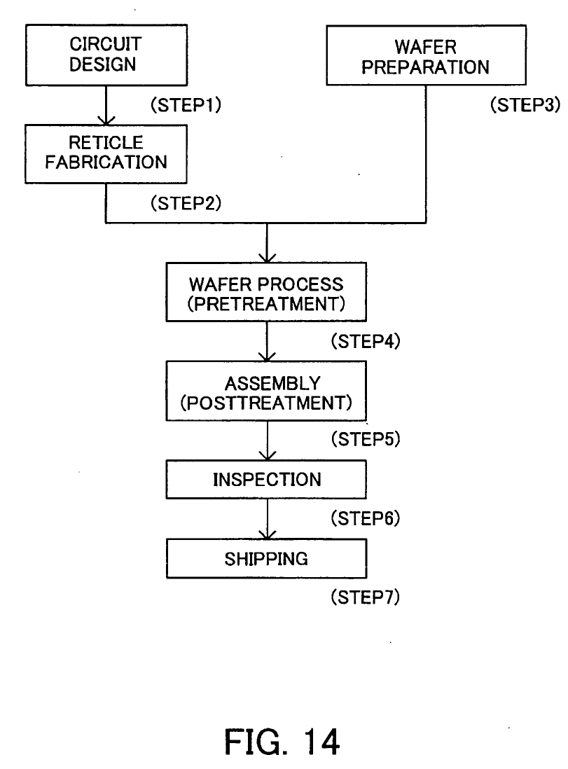

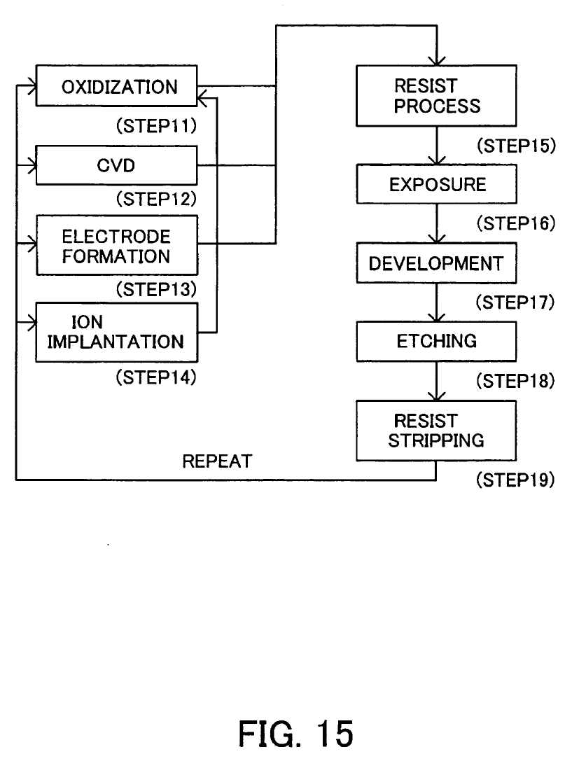

Referring to FIGS. 14 and 15, a description will now be given of an embodiment of a device manufacturing method using the above exposure apparatus 1. FIG. 14 is a flowchart for explaining a fabrication of devices (i.e., semiconductor chips such as IC and LSI, LCDs, CCDs, etc.). Here, a description will be given of a fabrication of a semiconductor chip as an example. Step 1 (circuit design) designs a semiconductor device circuit. Step 2 (mask fabrication) forms a mask having the designed circuit pattern. Step 3 (wafer preparation) manufactures a wafer using materials such as silicon. Step 4 (wafer process), which is referred to as a pretreatment, forms actual circuitry on the wafer through photolithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 15 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the mask onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer. The device manufacture method of the present invention may manufacture higher quality devices than the conventional one. Thus, a device manufacturing method using the exposure apparatus 1, and a resultant device also constitute one aspect of the present invention.

Further, the present invention is not limited to these preferred embodiments, and various modifications and changes may be made in the present invention without departing from the spirit and scope thereof.

This application claims a foreign priority benefit based on Japanese Patent Application No. 2005-056815, filed on Mar. 2, 2005, which is hereby incorporated by reference herein in its entirety as if fully set forth herein.

What is claimed is:

1. An exposure method for exposing an image of a pattern of a mask onto a plate while immersing, in liquid, a space between a final lens of a projection optical system and the plate, said method comprising the steps of:
obtaining temperature information of the liquid;
determining a correction amount for correcting a focus position of the image based on the temperature information; and
correcting the focus position of the image in synchronization with a scan position for one shot based on the correction amount.

2. An exposure method according to claim 1, wherein said correcting step also corrects a change of the focus position of the image due to an aberration of the projection optical system.

3. An exposure method according to claim 1, wherein said correcting step also corrects an inclination of a plane of the image.

4. An exposure method according to claim 1, wherein said correcting step includes the step of driving the projection optical system in an optical axis direction.

5. An exposure method according to claim 1, wherein said driving step changes a scan speed in accordance with a shot position.

6. An exposure method according to claim 1, wherein said driving step changes a time period to move to a next exposure position in accordance with a shot position.

7. An exposure method according to claim 1, wherein said correcting step includes the step of driving a wafer stage for supporting the plate in an optical axis direction and/or the step of inclining the wafer stage with respect to a plane perpendicular to the optical axis.

8. An exposure method for exposing a plate using exposure light while immersing, in liquid, a space between a final lens of a projection optical system and the plate, said method comprising the steps of:
obtaining temperature information of the liquid; and
irradiating non-exposure light onto the plate via the liquid based on the temperature information.

9. An exposure method according to claim 8, wherein said irradiating step irradiates a periphery around an exposure area on the plate which periphery extends in a direction orthogonal to a scan direction from the exposure area.

10. An exposure method according to claim 8, wherein said irradiating step irradiates a periphery around an exposure area of the plate which periphery extends in a scan direction from the exposure area.

11. An exposure method according to claim 8, wherein said irradiating step irradiates non-exposure light when a scan starts and does not irradiate the non-exposure light when the scan stops.

12. An exposure method according to claim 8, wherein said irradiating step irradiates non-exposure light to a periphery at a side that has no adjacent exposure area, in exposing the periphery around an exposure area.

13. An exposure method according to claim 8, wherein said irradiating step irradiates non-exposure light to a periphery around an exposure area so as to cancel a temperature difference between the exposure area and the periphery around the exposure area by changing a distribution of an irradiation amount by location and by time.

14. An exposure method for exposing a plate using exposure light while immersing, in liquid, a space between a final lens of a projection optical system and the plate, said method comprising the steps of:
obtaining information of a temperature of the liquid; and
irradiating non-exposure light onto the plane an area whose temperature is below an average of the temperature of the liquid above a periphery of an exposure area of the plate.

15. An exposure apparatus comprising a mode for executing an exposure method according to claim 1.

16. A device manufacturing method comprising the steps of:
exposing a plate using an exposure apparatus according to claim 15; and
developing the plate that has been exposed.
